(19) United States
(12) Patent Application Publication
(10) Pub. No.: US 2016/0039107 A1
(43) Pub. Date: Feb. 11, 2016

(54) Multi-Bladed Universal Cutting Station

(71) Applicant: Ramesh Varanasi, Ellicott City, MD (US)

(72) Inventor: Ramesh Varanasi, Ellicott City, MD (US)

(21) Appl. No.: 14/822,869

(22) Filed: Aug. 10, 2015

Related U.S. Application Data
(60) Provisional application No. 62/035,249, filed on Aug. 8, 2014.

(51) Int. Cl. B26D 3/18; B26D 1/30

(52) U.S. Cl. CPC B26D 3/185; B26D 1/30

(57) ABSTRACT

A multi-bladed universal cutting station has a cutting board, a pivot, a plurality of blades and a handle. The plurality of blades is pivotally connected to the surface of the cutting board by the pivot, and the handle is connected to the plurality of blades opposite the pivot to provide a means to leverage the plurality of blades downward in order to cut food or other items. A plurality of cutting grooves in the surface of the cutting board receive the blades in the lowered position, preventing dulling of the blades and food particles from becoming trapper between the blades.

The current application claims a priority to the U.S. Provisional Patent application Ser. No. 62/035,249 filed on Aug. 8, 2014. The current application is filed on Aug. 10, 2015, whereas Aug. 8, 2015 and Aug. 9, 2015 were on a weekend.

### FIELD OF THE INVENTION

The present invention relates generally to knives and cutting boards and, more particularly, relates to a cutting board configured with multiple angled blades pivotally mounted thereto.

### BACKGROUND OF THE INVENTION

Conventionally, singular knives have been used to chop, mince, dice, or otherwise cut assortments of fruits, vegetables, meats, or other food items on cutting boards. Cutting multiple food items into many pieces with only a single knife can prove to be time-consuming, tiring, and sometimes produces less than desirable results. It can be difficult to keep certain items from sliding under the pressure of the knife, in which case a person may be forced to use his or her free hand to hold down the item being cut. This poses a clear safety concern. Additionally, the constant striking of the knife's blade against cutting boards causes dulling over the useful life of the knife. A dull blade only serves to make a cutting job more difficult.

Multi-blade knives are known to be faster than single bladed knives when used for larger quantity cutting jobs. However, current multi-blade knives do not provide adequate means of effectively gripping food items without requiring a person to use his or her own hands to hold said item. Also, multi-blade knives still become difficult to use and produce poor cuts when the blades begin to dull. Thus, the present invention provides a new multi-blade knife and specially configured cutting board that can be used to cleanly and safely cut a wide assortment of fruits, vegetables, meats, or other sliceable food items with relative ease, all the while preventing any significant dulling of the blades over time.

### BRIEF DESCRIPTION OF THE DRAWINGS

FIG. 1 is a front elevated perspective view of the present invention in the raised position.

FIG. 2 is a rear lowered perspective view of the present invention in the raised position.

FIG. 3 is a front elevated perspective view of the present invention in the lowered position.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a universal cutter, which may be used to cleanly and safely cut a wide assortment of fruits, vegetables, meats, or other sliceable food items with relative ease, all the while preventing any significant dulling of the blades over time.

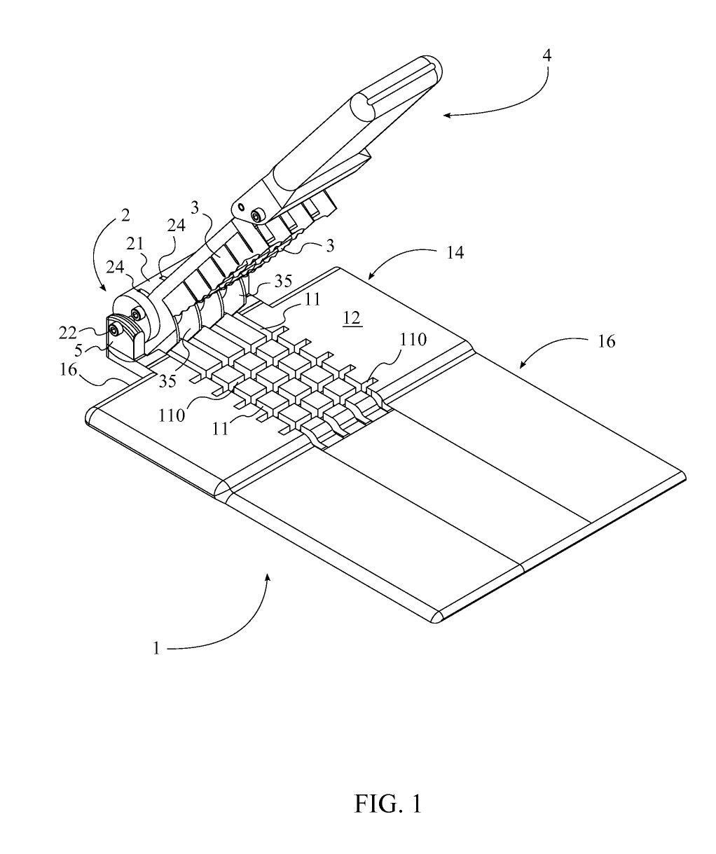

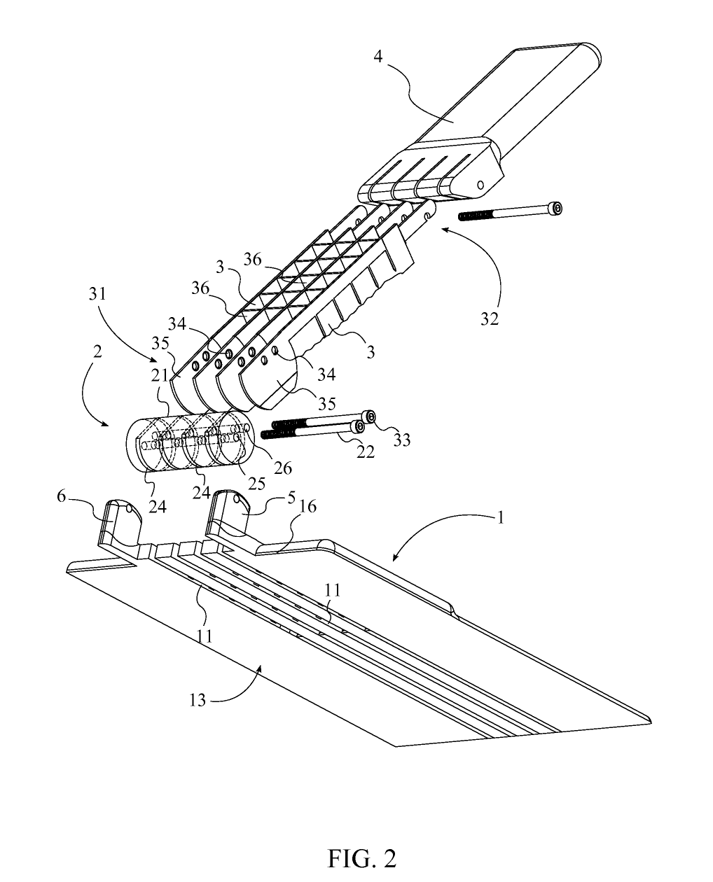

Referring to FIGS. 1-2, the preferred embodiment of the present invention generally comprises a cutting board 1, a pivot 2, a plurality of blades 3, and a handle 4. The cutting board 1 comprises a plurality of cutting grooves 11, which are oriented parallel to each other and longitudinally on the cutting board 1. The plurality of cutting grooves 11 are spaced apart from each other on the cutting board 1, preferably equally spaced apart from each other laterally. Each of the plurality of cutting grooves 11 traverses into the cutting board 1 from a top surface 12 of the cutting board 1 toward a bottom surface 13 of the cutting board 1. In one embodiment, the plurality of cutting grooves 11 completely penetrates through the cutting board 1 from the top surface 12 to the bottom surface 13. In another embodiment, the plurality of cutting grooves 11 traverses only a portion of the thickness of the cutting board 1 and does not penetrate the bottom surface 13. The plurality of cutting grooves 11 provides a space for the plurality of blades 3 to be received while cutting food or other objects, so that the plurality of blades 3 does not come into contact with the cutting board's 1 rigid surface in order to avoid dulling the plurality of blades 3. Additionally, the existence of the plurality of cutting grooves 11 helps to avoid any pieces of vegetable, meat or other food items being caught between the plurality of blades 3. In the preferred embodiment, the plurality of blades 3 are able to be inserted completely into the plurality of cutting grooves 11 so that pieces of food items are able to be completely pushed out of the plurality of blades 3 and the plurality of cutting grooves 11. As an additional result, sufficient pressure can be applied food items that are soft and less easily cut to enable clean cuts on items such as moisture-saturated or old vegetables.

In the preferred embodiment, the cutting board 1 comprises a cutting portion 14 and an extended portion 15. The plurality of cutting grooves 11 traverse into the cutting portion 14. The cutting portion 14 is positioned adjacent to the pivot 2 so that the pivot 2 is adjacent to the plurality of cutting grooves 11. The extended portion 15 is connected adjacent to the cutting portion 14 opposite the pivot 2. The extended portion 15 is not particularly important to the present invention, however the extended portion 15 is desired in order to provide a space for food items which have been cut to be cleared from the cutting portion 14 in order to make room for new items.

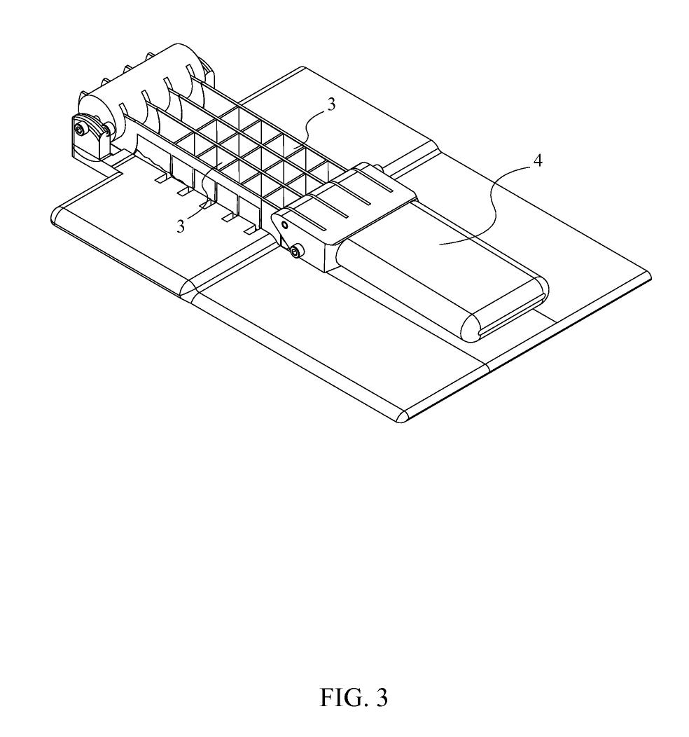

The pivot 2 provides the user with a mechanical advantage in comparison to manually cutting a food item with a single knife, that in applying downward force to the handle 4 and the plurality of blades 3, torque is applied through the plurality of blades 3 in order to transfer more cutting force onto a food item. The pivot 2 is connected to the cutting board 1 adjacent to a perimeter 16 of the cutting board 1 and adjacent to the plurality of cutting grooves 11. To clarify, the pivot 2 is laterally aligned with the plurality of cutting grooves 11, and preferably laterally centrally positioned with the cutting board 1, in order to enable the plurality of blades 3 to be aligned with the plurality of cutting grooves 11. The pivot 2 is also positioned adjacent to the top surface 12 of the cutting board 1 opposite the bottom surface 13 of the cutting board 1. It is contemplated, however, that the pivot 2 may be positioned in any vertical position with respect to the cutting board 1, so long as a mechanical linkage exists that allows the plurality of blades 3 to achieve the desired angle with the cutting board 1 and thus the plurality of cutting grooves 11. More specifically, the plurality of blades 3 should be parallel or close to parallel with the top surface 12 of the cutting board 1 when the plurality of blades 3 is in a lowered position after a user presses the plurality of blades 3 downward from a raised position in order to cut food or any other object desired to be cut with the present invention. FIG. 3 shows the handle 4 and the plurality of blades 3 in the lowered position.

The pivot 2 is connected to the cutting board 1 by any useful and appropriate means. However, in the preferred embodiment of the present invention, a first pivot support 5 and a second pivot support 6 are connected to the cutting board 1, positioned opposite each other across the plurality of grooves adjacent to the perimeter 16 of the cutting board 1. The pivot 2 suspended and rotatably connected at opposite axial ends between the first pivot support 5 and the second pivot support 6.

More specifically, in the preferred embodiment of the present invention, the pivot 2 rotates about a pivot axle 22, and the pivot 2 further comprises a cylindrical body 23, a plurality of blade insertion slots 24, and an axle hole 25. The plurality of blade insertion slots 24 traverse into the cylindrical body 23 perpendicularly to an axis of the cylindrical body 23. The axle hole 25 traverses axially through the cylindrical body 23. The pivot axle 22 is positioned within the axle hole 25, and the pivot axle 22 is connected between the first pivot support 5 and the second pivot support 6, enabling the cylindrical body 23 of the pivot 2 to rotate about the axis of the cylindrical body 23 about the pivot axle 22.

In the preferred embodiment of the present invention, the pivot 2 comprises a rotational dampener 21. Although not of paramount importance to the functionality of the present invention, the rotational dampener 21 serves a useful safety feature to users of the present invention. The rotational dampener 21 is operationally integrated with the pivot 2 such that the rotation of the plurality of blades 3 and connected handle 4 is slowed while going from the raised position to the lower position. The extent of the dampening effect should be such that the force applied by a user to the handle 4 to cut a food item is not impeded to the point where the cutting functionality is impeded, but should the handle 4 and plurality of cutting blades be dropped from the raised position, the plurality of blades 3 and the handle 4 will rotate downwards toward the cutting board 1 slowly enough that a user's hand will not be cut or otherwise injured if the plurality of blades 3 accidentally fall onto the user's hand. The rotational dampener 21 is rotatably connected between the first pivot support 5 and the second pivot support 6, and the plurality of blades 3 is connected to the rotational dampener 21. The rotational dampener 21 may be considered to be the pivot 2, as both serve the same function of allowing the plurality of blades 3 to rotate, but with the rotational dampener 21 adding the functionality of slowing the descent of the plurality of blades 3 from the raised position to the lowered position. Any relevant and useful means and components for implementing the rotational dampener 21 may be utilized.

The plurality of blades 3 comprises a proximal end 31 and a distal end 32 positioned opposite each other along the plurality of blades 3. The proximal end 31 of each of the plurality of blades 3 is connected to the pivot 2 opposite the cutting board 1, so that the plurality of blades 3 is pivotally connected to the cutting board 1 by the pivot 2. The aforementioned pivot Zing functionality allowing the plurality of blades 3 to be pressed by a user into the cutting board 1 is the fundamental purpose of the present invention, enabling a user to easily cut a food item or other item by applying torque to the plurality of blades 3 toward the cutting board 1 from the raised position. In the preferred embodiment of the present invention, each of the plurality of blades 3 is oriented longitudinally with respect to the cutting board 1 and parallel to each other. In other embodiments, however, the plurality of blades 3 may be oriented at various other angles with respect to each other in order to provide alternate cutting patterns. Also of significant importance in the present invention, each of the plurality of blades 3 is aligned so that in the lowered position, each of the plurality of blades 3 is received by one of the cutting grooves. In the preferred embodiment of the present invention, since each of the plurality of blades 3 and each of the plurality of cutting grooves 11 is parallel to each other and oriented longitudinally, each of the plurality of blades 3 is laterally aligned with one of the plurality of cutting grooves 11.

In the preferred embodiment of the present invention, each of the plurality of blades 3 further comprises a guide tab 35, which is connected at the proximal end 31 of each of the plurality of blades 3. Each guide tab 35 is oriented parallel to its respective blade, and is positioned adjacent to and laterally aligned with one of the plurality of cutting grooves 11, between the pivot 2 and the cutting board 1. The guide tabs 35 enable the plurality of blades 3 to adequately become seated within the plurality of cutting grooves 11. During cutting, it is possible for the plurality of blades 3 to become slightly bent in the lateral direction depending on the shape of the item to be cut and the direction of force applied by the user, causing one of more of the plurality of blades 3 to potentially miss the plurality of cutting grooves 11 and come into contact with the cutting board 1 surface instead. The guide tabs 35 ensure that the plurality of blades 3 become properly inserted into the plurality of cutting grooves 11, since upon rotating from the raised position to the lowered position, the guide tabs 35 are the first part of the plurality of blades 3 which become inserted into the plurality of cutting grooves 11, thus guiding the plurality of blades 3 into the plurality of cutting grooves 11.

The preferred embodiment further comprises a blade anchor axle 33, and the pivot 2 further comprises a blade attachment hole 26. The blade attachment hole 26 traverses through the cylindrical body 23 of the pivot 2 parallel to the axle hole 25. Each of the plurality of blades 3 comprises a blade anchor hole 34, and the blade anchor axle 33 is positioned within the blade attachment hole 26 and the blade anchor hole 34 of each of the plurality of blades 3.

The handle 4 is connected to the distal end 32 of the plurality of blades 3 opposite the pivot 2. As a result, the plurality of blades 3 is positioned and connected between the pivot 2 and the handle 4. The purpose of the handle 4 is to provide a user with a convenient apparatus to manipulate the plurality of blades 3 from the raised position to the lowered position in order to cut a food item. It is contemplated that the handle 4 may be embodied in many forms, including, but not limited to, a generally rectangular, elongated body, a triangular body, a circular or spherical body, or a handle 4 body generally conforming to and accommodating of a human hand or fingers. In the preferred embodiment, each of the plurality of blades 3 is rigidly connected to the handle 4, though it is contemplated that alternate embodiments may exist where the handle 4 may rotate relative to the plurality of blades 3.

In one embodiment, the present invention solely comprises the plurality of blades 3 being oriented longitudinally. In another embodiment, the present invention additionally comprises a plurality of medial blades 36. The plurality of medial blades 36 are perpendicularly connected between the plurality of blades 3, spaced apart from each other along the plurality of blades 3 between the proximal end 31 and the distal end 32 according to a medial separation pattern. The plurality of medial blades 36 provides additional cutting functionality in order to cut food items into smaller rectangular portions as opposed to longitudinal slices without the plurality of medial blades 36.

In order to accommodate the plurality of medial blades 36, a plurality of medial cutting grooves 110 are additionally comprised in the preferred embodiment of the present invention. Similarly to the plurality of cutting grooves 11, the plurality of medial cutting grooves 110 traverses into the cutting board 1 from the top surface 12 toward the bottom surface 13. In the preferred embodiment, the plurality of medial cutting grooves 110 are oriented parallel to each other and perpendicular to the plurality of cutting grooves 11 such that the plurality of medial cutting grooved are oriented laterally on the cutting board 1. The plurality of medial cutting grooves 110 are spaced apart from each other according to the medial separation pattern. In the preferred embodiment of the present invention, the medial separation pattern entails the plurality of medial blades 36 and the plurality of medial grooves being equally spaced apart from each other longitudinally. It is contemplated, however, that in alternate embodiments the medial separation pattern may comprise differing amounts of spacing between the plurality of medial blades 36 and between the plurality of medial cutting grooves 110.

Although the invention has been explained in relation to its preferred embodiment, it is to be understood that many other possible modifications and variations can be made without departing from the spirit and scope of the invention as hereinafter claimed.

What is claimed is:

1. A multi-bladed universal cutting station comprises:
a cutting board;
a pivot;
a plurality of blades;
a handle;
the cutting board comprises a plurality of cutting grooves;
the plurality of blades comprises a proximal end and a distal end;
the plurality of cutting grooves being oriented parallel to each other, wherein the plurality of cutting grooves are oriented longitudinally on the cutting board;
the plurality of cutting grooves being spaced apart from each other on the cutting board;
the plurality of cutting grooves traversing into the cutting board from a top surface of the cutting board toward a bottom surface of the cutting board;
the pivot being connected to the cutting board adjacent to the plurality of cutting grooves;
the pivot being positioned adjacent to the top surface of the cutting board opposite the bottom surface of the cutting board;
the proximal end and the distal end being positioned opposite each other along the plurality of blades;
the proximal end of each of the plurality of blades being connected to the pivot opposite the cutting board, wherein the plurality of blades is pivotally connected to the cutting board by the pivot;
each of the plurality of blades being oriented longitudinally and parallel to each other;
each of the plurality of blades being laterally aligned with one of the plurality of cutting grooves;
the handle being connected to the distal end of the plurality of blades opposite the pivot, wherein the plurality of blades is positioned between the pivot and the handle;

2. The multi-bladed universal cutting station as claimed in claim 1 comprises:
the plurality of cutting grooves being equally spaced apart from each other;
the plurality of blades being equally spaced apart from each other;

3. The multi-bladed universal cutting station as claimed in claim 1 comprises:
the cutting board comprises a cutting portion and an extended portion;
the cutting portion being positioned adjacent to the pivot;
the extended portion being connected adjacent to the cutting portion opposite the pivot;
the plurality of cutting grooves traversing into the cutting portion;

4. The multi-bladed universal cutting station as claimed in claim 1 comprises:
the pivot being positioned adjacent to a perimeter of the cutting board;

5. The multi-bladed universal cutting station as claimed in claim 1 comprises:
the pivot being laterally centrally positioned with the cutting board;

6. The multi-bladed universal cutting station as claimed in claim 1 comprises:
a first pivot support and a second pivot support;
the first pivot support and the second pivot support being positioned opposite each other across the plurality of cutting grooves;
the first pivot support and the second pivot support being connected to the cutting board;
the pivot being rotatably connected between the first pivot support and the second pivot support;

7. The multi-bladed universal cutting station as claimed in claim 6 comprises:
the first pivot support and the second pivot support being positioned adjacently to a perimeter of the cutting board;

8. The multi-bladed universal cutting station as claimed in claim 6 comprises:
the pivot comprises a rotational dampener;
the rotational dampener being rotatably connected between the first support and the second support;
the plurality of blades being connected to the rotational dampener;

9. The multi-bladed universal cutting station as claimed in claim 1 comprises:
each of the plurality of blades being connected between the pivot and the handle;

10. The multi-bladed universal cutting station as claimed in claim 1 comprises:
each of the plurality of blades being rigidly connected to the handle;

11. The multi-bladed universal cutting station as claimed in claim 1 comprises:
a pivot axle;
the pivot comprises a cylindrical body, a plurality of blade insertion slots, and an axle hole;
the plurality of blade insertion slots traversing into the cylindrical body perpendicularly to an axis of the cylindrical body;
the axle hole traversing axially through the cylindrical body;
the pivot axle being positioned within the axle hole;
the pivot axle being connected between the first pivot support and the second pivot support, wherein the cylindrical body rotates about the axis on the pivot axle;

12. The multi-bladed universal cutting station as claimed in claim 1 comprises:
a blade anchor axle;
the pivot comprises a blade attachment hole;
the blade attachment hole traversing through the cylindrical body parallel to the axle hole;
each of the plurality of blades comprises a blade anchor hole;
the blade anchor axle being positioned within the blade attachment hole and the blade anchor hole of each of the plurality of blades;

13. The multi-bladed universal cutting station as claimed in claim 1 comprises:
each of the plurality of blades further comprises a guide tab;
the guide tab being connected at the proximal end of each of the plurality of blades;
the guide tab being positioned between the pivot and the cutting board;
the guide tab being laterally aligned with one of the plurality of cutting grooves;

14. The multi-bladed universal cutting station as claimed in claim 1 comprises:
a plurality of medial blades;
the plurality of medial blades being perpendicularly connected between the plurality of blades, wherein the plurality of medial blades are oriented laterally;
the plurality of medial blades being spaced apart from each other along the plurality of blades between the proximal end and the distal end according to a medial separation pattern;

15. The multi-bladed universal cutting station as claimed in claim 14 comprises:
a plurality of medial cutting grooves;
the plurality of medial cutting grooves traversing into the cutting board from the top surface toward the bottom surface;
the plurality of medial cutting grooves being oriented parallel to each other and perpendicular to the plurality of cutting grooves, wherein the plurality of medial cutting grooves are oriented laterally on the cutting board;
the plurality of medial cutting grooves being spaced apart from each other on the cutting board according to the medial separation pattern;
